(19) United States
(12) Patent Application Publication
(10) Pub. No.: US 2015/0137429 A1
(43) Pub. Date: May 21, 2015

(54) FABRICATION METHOD FOR A THREE DIMENSIONAL MICRO-STRUCTURE ON POLYMERS

(71) Applicant: National Taiwan University of Science and Technology, Teipei City (TW)

(72) Inventor: Chun-Hui Chung, Taipei City (TW)

(73) Assignee: National Taiwan University of Science and Technology, Teipei City (TW)

(21) Appl. No.: 14/263,722

(22) Filed: Apr. 28, 2014

(30) Foreign Application Priority Data
Nov. 20, 2013 (TW) 102142199

(51) Int. Cl. B29C 59/16

(52) U.S. Cl. CPC B29C 59/16; B29L 2031/772
USPC 264/496

(57) ABSTRACT

The present invention provides a fabrication method of a three dimensional micro-structure on polymers. The fabrication method of the present invention comprises the following steps of: preparing a sacrifice material; micro-processing the sacrifice material to form a pattern with micro-features; putting the sacrificed material with the micro-features into a mold and injecting a liquid state polymer into the mold; and solidifying the polymer by using a predetermined process and removing the sacrificed material through a guiding channel to create a three dimensional micro-structure on polymers.

### PRIORITY CLAIM

This application claims the benefit of the filing date of Taiwan Patent Application No. 102142199, filed Nov. 20, 2013, entitled “FABRICATION METHOD FOR A THREE DIMENSIONAL MICRO-STRUCTURE ON POLYMERS,” and the contents of which is hereby incorporated by reference in its entirety.

### FIELD OF THE INVENTION

The present invention relates to a fabrication method for a three dimensional micro-structure, more particularly, to a fabrication method for a three dimensional micro-structure on polymers.

### BACKGROUND OF THE INVENTION

Micro-structures have been comprised in daily products for a long time, for instance any kind of sensor or detector. In the prior art, special material and a special manufacturing process must be used to create the micro structure because the scale is extremely small. The most popular method for creating the micro-structure is to use photolithography technology, then copy the micro-character of the mold core onto a product or micro-processing the soft material through a micro-carving machine. Therefore, the product cannot be processed using traditional ways of processing large product.

Micro-channel is a field which is developed from micro electro mechanical system (MEMS). Through micro-electronic processing technology, the containers, pumps, valves and channels in micro-scale can be created on the micro-chip, which allows the liquid control unit to become tiny and integrates the detection and sensation onto a chip. Nowadays, the micro-channel device is usually used to detect the disease of an organism.

Furthermore, because the polymers, such as Polymethylmethacrylate (PMMA) and Polydimethylsiloxane (PDMS), have the characteristics of being cheap, having good light transparency and being easy to process, they are usually used to create the micro-structure and micro-channel. In the prior art, people usually use rollover or cut forming techniques to create the micro-structure, but these techniques are not able to create complex three dimensional structures in the micro-channel. Other prior arts, such as rapid prototyping or photolithography, require more time and money. Therefore, these techniques are economically inefficient.

Furthermore, in the prior art, investment casting uses disposable material to create a pattern and then using refractory materials in fit with a set thickness to cover the pattern to mold the pattern into a mold. After filling the mold material, there is no need to separate the mold and remove the pattern as the pattern and the mold are heated at the same time. After that the pattern and mold are heated, the pattern will begin to melt and the melted pattern will flow out and form a cavity. Usually wax, mercury, styrofoam or thermo-viscoplastic are used as the material for the pattern. However, the investment casting in the prior art requires the use of refractory materials with a set thickness to cover the pattern to work as a mold, which raises the cost and complexity.

Compared to the prior art, the present invention provides a fabrication method for a three dimensional micro-structure on polymers, that combines the technology of micro-processing and polymer casting. The micro-processing sacrifices material to form a pattern with micro-features first, and then without using refractory materials, directly puts the sacrifice material with the micro-features into the mold and injects a liquid state polymer into the mold. After solidifying the polymer by a predetermined process, the micro-processing heats the sacrifice material to remove the sacrifice material out of the polymer and forms the three dimensional micro-structure on polymers.

### SUMMARY OF THE INVENTION

The present invention provides a fabrication method for a three dimensional micro-structure on polymers, comprising the following steps of: preparing a sacrifice material; micro-processing the sacrifice material to form a pattern with micro-features; putting the sacrifice material with the micro-features into the mold and injecting a liquid state polymer into the mold; solidifying the polymer by a predetermined process; and removing the sacrifice material out of the polymer to form the three dimensional micro-structure on polymers.

Furthermore, the predetermined process of the present invention is according to the characteristic of the polymer. The polymer can be solidified by a photo curing method or a chemical reaction. The melting point of the polymers of the present invention is higher than the melting point of the sacrifice material. The polymers of the present invention can be Polymethylmethacrylate (PMMA), Polydimethylsiloxane (PDMS) or Epoxy and the sacrifice material can be wax.

Furthermore, the method of removing the sacrifice material out of the polymer of the present invention can be through heating, wherein the heating temperature to remove the sacrificed material is higher than the melting point of the sacrifice material and lower than the melting point of the polymers. After being heated, the melted sacrifice material in a liquid state can flow out of the polymers through the guiding channel.

Finally, after applying the fabrication method for the three dimensional micro-structure on polymers of the present invention, the finished three dimensional micro-structure can become a micro-channel.

Compared to the prior art, the present invention provides a fabrication method for a three dimensional micro-structure on polymers, which combines the technology of micro-processing, polymer casting and the usage of sacrifice material. Micro-processing the sacrifice material to form a pattern with micro-features first, and then without using refractory materials, directly putting the sacrificed material with the micro-features into the mold and injecting a liquid state polymer into the mold. After the polymer is solidified by a predetermined process, the sacrifice material is removed from the polymer using heat and forms the three dimensional micro-structure on polymers. The present invention overcomes the problem of creating a three dimensional micro-structure in the prior art, where the heating temperature to remove the sacrificed material is much lower than before, which also reduces carbon emission.

Many other advantages and features of the present invention will be further understood by the following detailed description and the appended drawings.

### BRIEF DESCRIPTION OF THE DRAWINGS

Some of the embodiments will be described in detail, with reference to the following figures, wherein like designations denote like members, wherein:

FIG. 1 is a flow chart of the fabrication method for the three dimensional micro-structure on polymers in an embodiment of the invention;

FIG. 2 shows the sacrifice material of the fabrication method for the three dimensional micro-structure on polymers in an embodiment of the invention;

FIG. 3 shows the sacrifice material with the micro-features of the fabrication method for the three dimensional micro-structure on polymers in an embodiment of the invention;

FIG. 4 shows the relative position between the sacrifice material with the micro-features and the polymer of the fabrication method for the three dimensional micro-structure on polymers in an embodiment of the invention;

FIG. 5 shows the finished product of the fabrication method for the three dimensional micro-structure on polymers in an embodiment of the invention;

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

The following statement will explain the fabrication method for the three dimensional micro-structure on polymers of the present invention in detail.

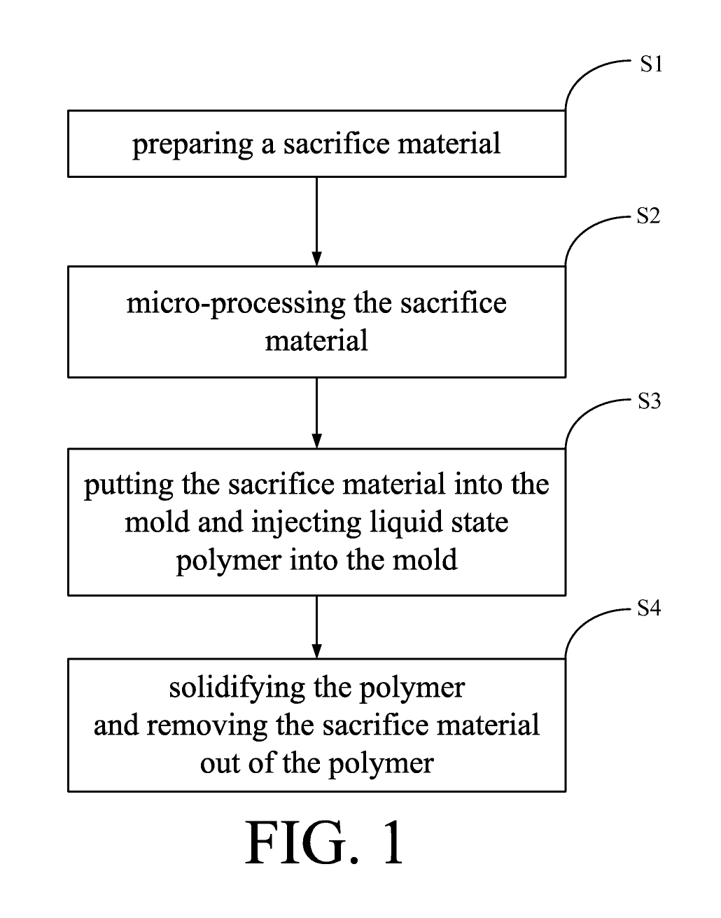

Please refer to FIG. 1, which illustrates a flow chart of the fabrication method for the three dimensional micro-structure on polymers in an embodiment of the invention. The present invention provides a fabrication method for the three dimensional micro-structure on polymers, comprising the following steps of: (S1) preparing a sacrifice material 10; (S2) micro-processing the sacrifice material 10 to form a pattern with micro-features 12; (S3) putting the sacrifice material 10 with the micro-features 12 into the mold (not shown in the FIG.) and injecting a liquid state polymer 30 into the mold (not shown in the FIG.); and (S4) solidifying the polymer 30 by using a predetermined process and removing the sacrifice material 10 out of the polymer 30 to form the three dimensional micro-structure on the polymers 1. It is worth noting that the three dimensional micro-structure of the present invention can be a micro-channel in an embodiment.

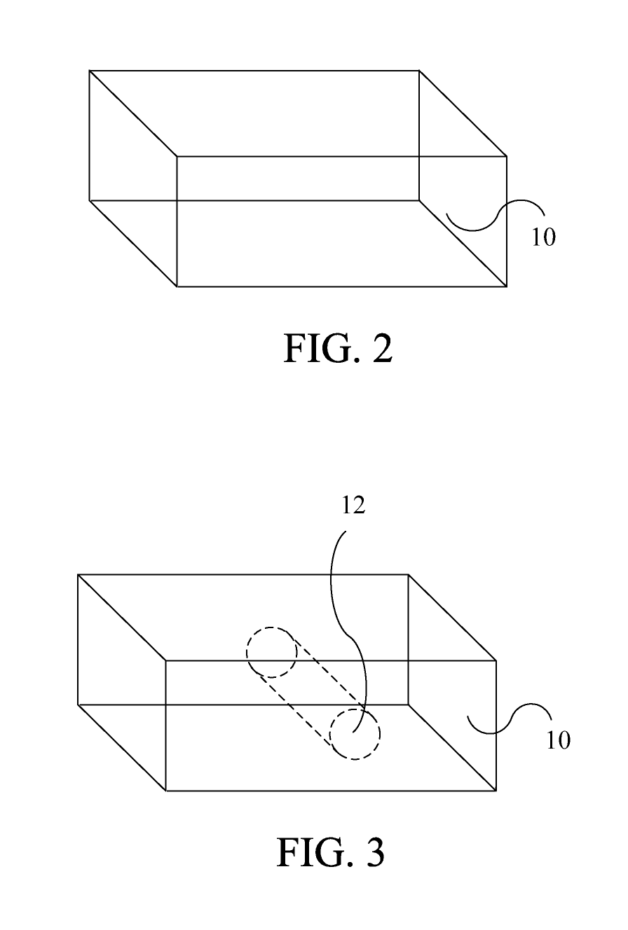

Please refer to FIG. 2, which illustrates the sacrifice material of the fabrication method for the three dimensional micro-structure on polymers in an embodiment of the invention. In step (S1) of the present invention, the shape of the sacrifice material 10 is not limited to a rectangle. The shape of the sacrifice material 10 can be adjusted by the user according to the design requirement. Furthermore, the sacrifice material 10 can be selected by the user according to the design requirement, wherein the melting point of the sacrifice material 30 must be lower than the melting point of the polymers of the present invention, such as wax or gypsum.

Please refer to FIG. 3, which illustrates the sacrifice material with the micro-features of the fabrication method for the three dimensional micro-structure on polymers in an embodiment of the invention. In step (S2) of the present invention, the sacrifice material 10 is micro-processed to form a pattern with micro-features 12, wherein the shape of the micro-features 12 is not limited to a cylinder. The shape of the micro-features 12 can be adjusted by the user according to the design requirement.

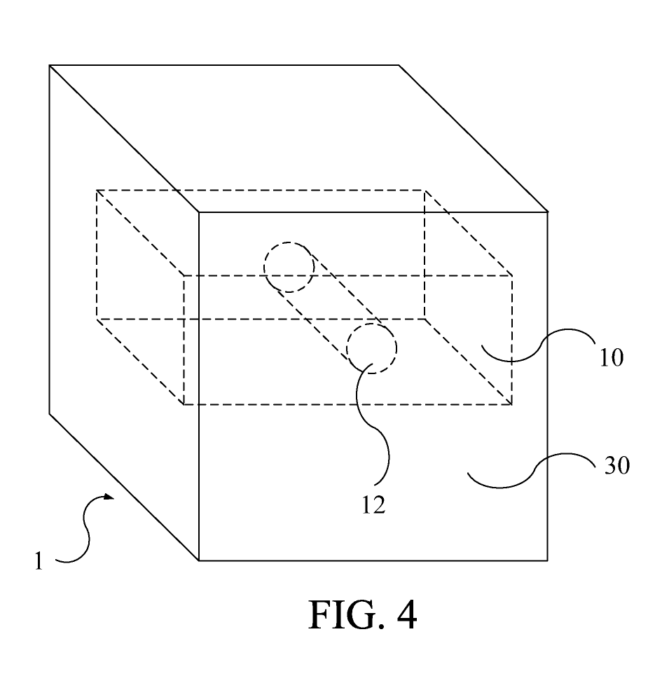

Please refer to FIG. 4, which illustrates the relative position between the sacrificed material with the micro-features and the polymer of the fabrication method for the three dimensional micro-structure on polymers in an embodiment of the invention. In step (S3) of the present invention, the sacrifice material 10 is put with the micro-features 12 at a predetermined forming position in the mold (not shown in the FIG.), where after the sacrifice material 10 with the micro-features 12 is fixed, injecting a liquid state polymer 30 into the mold (not shown in the FIG.) to make the sacrificed material 10 with the micro-features 12 and the liquid state polymer 30 to coexist in the mold (not shown in the FIG.) at the same time.

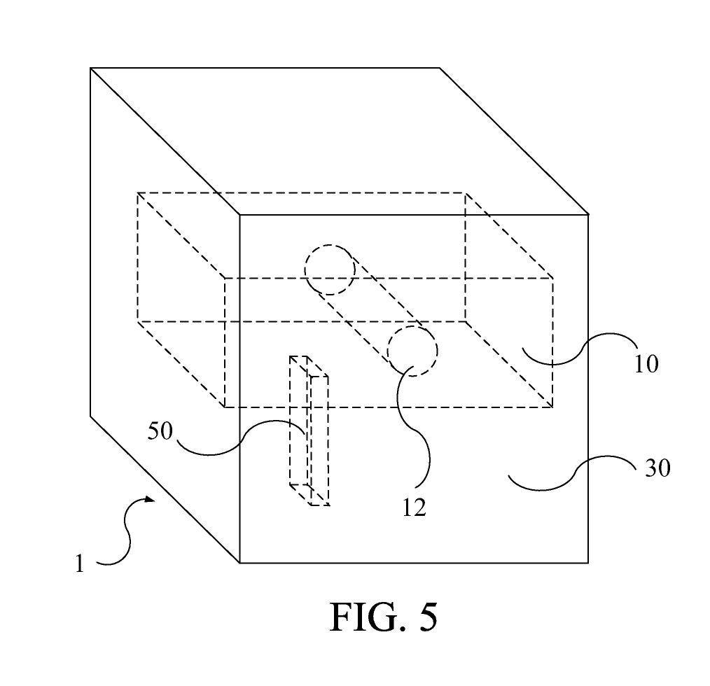

Please refer to FIG. 5, which illustrates the finished product of the fabrication method for the three dimensional micro-structure on polymers in an embodiment of the invention. In step (S4) of the present invention, the polymer 30 is solidified by a predetermined process and the sacrifice material 10 is removed out of the polymer 30 to form the three dimensional micro-structure on the polymers 1. The polymer 30 can be selected by the user according to the design requirements, wherein the melting point of the polymer 30 must be higher than the melting point of the sacrifice material 10, such as Polymethylmethacrylate (PMMA), Polydimethylsiloxane (PDMS) or Epoxy. Furthermore, the predetermined process of step (S4) in the present invention depends on the characteristic of the polymer 30. The polymer 30 can be solidified by a photo curing method or a chemical reaction. In an embodiment, the method of removing the sacrificed material 10 out of the polymer 30 of the present invention can be through heating, wherein the heating temperature to remove the sacrifice material 10 is higher than the melting point of the sacrificed material 10 and lower than the melting point of the polymers 30. Furthermore, the fabrication method for the three dimensional micro-structure on the polymers 30 of the present invention further comprises the following step of: creating a guiding channel 50 for guiding the melted sacrifice material 10 out of the polymers 30. Finally, the three dimensional micro-structure on the polymers is created through step (S1) to step (S4) of the present invention (shown as FIG. 5).

Compared with the prior art, the present invention provides a fabrication method for a three dimensional micro-structure on polymers, which combines the technology of micro-processing, polymer casting and the usage of a sacrifice material. Micro-processing the sacrifice material to form a pattern with micro-features first, without the use of refractory materials of set thickness to cover a pattern to make a pattern work as a mold, and instead directly putting the sacrifice material with the micro-features into the mold and injecting a liquid state polymer into the mold. After solidifying the polymer by using a predetermined process, the sacrifice material is heated to remove the sacrifice material out of the polymer and forms the three dimensional micro-structure on polymers. The present invention overcomes the problem of creating a three dimensional micro-structure in the prior art. The heating temperature to remove the sacrifice material is much lower than the prior art, which also reduces carbon emissions.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

1. A fabrication method for a three dimensional micro-structure on polymers, comprising the following steps of:
preparing a sacrifice material;
micro-processing the sacrifice material to form a pattern with micro-features;
putting the sacrifice material with the micro-features into a mold and injecting a liquid state polymer into the mold; and
solidifying the polymer by a predetermined process and heating the sacrifice material to remove the sacrifice material out of the polymer for forming the three dimensional micro-structure on polymers.

2. The fabrication method for the three dimensional micro-structure on polymers of claim 1, wherein the predetermined process can be a photo curing method or a chemical reaction.

3. The fabrication method for the three dimensional micro-structure on polymers of claim 1, wherein the melting point of the polymers is higher than the melting point of the sacrifice material.

4. The fabrication method for the three dimensional micro-structure on polymers of claim 1, wherein the heating temperature for removing the sacrifice material is higher than the melting point of the sacrifice material and lower than the melting point of the polymers.

5. The fabrication method for the three dimensional micro-structure on polymers of claim 1, wherein the three dimensional micro-structure can be a micro-channel.

6. The fabrication method for the three dimensional micro-structure on polymers of claim 1, wherein the polymers can be Polymethylmethacrylate (PMMA), Polydimethylsiloxane (PDMS) or Epoxy.

7. The fabrication method for the three dimensional micro-structure on polymers of claim 1, wherein the sacrifice material can be wax.

8. The fabrication method for the three dimensional micro-structure on polymers of claim 1 further comprises the following step of:
creating a guiding channel for guiding the melted sacrifice material out of the polymers.
